(19) United States
(12) Patent Application Publication
(10) Pub. No.: US 2004/0130987 A1
(43) Pub. Date: Jul. 8, 2004

(54) Method and device of detecting the disk type of an optical disc

(76) Inventors: Chien-Li Hung, Taipei (TW); Kuo-Pei Weng, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/601,380

(22) Filed: Jun. 23, 2003

(30) Foreign Application Priority Data
Jan. 3, 2003 (TW) 92100137

(51) Int. Cl. G11B 7/00

(52) U.S. Cl. 369/53.2; 369/53.3

(57) ABSTRACT

A method of detecting a type of optical disc according to the rotation speed of a spindle motor loading the optical disc. First, the spindle motor is driven with a signal having a predetermined waveform. Next, the rotation speed of the spindle motor is detected by a Hall sensor and compared with a first predetermined rotation speed and a second predetermined rotation speed. When the detected rotation speed is faster than the first predetermined rotation speed, it is determined that there is no optical disc on the spindle motor, and it is determined that there is a mini-type optical disc on the spindle motor when the detected rotation speed is between the first predetermined rotation speed and the second predetermined rotation speed, and a normal-type optical disc is determined when the detected rotation speed is slower than the second predetermined rotation speed.

### BACKGROUND OF THE INVENTION

1. Field of the Invention

The present invention relates in general to a method of detecting the disc type of an optical disc. In particular, the present invention relates to a method of automatically detecting the disc type of a loaded optical disc, for example, an optical disc of 8 cm or 12 cm in diameter.

2. Description of the Related Art

The dramatic improvement of computer hardware and network technology has resulted in increased requirements for data storage media. Some data requires large storage in spite of being compressed, particularly multi-media data, such as video or audio. Thus, data storage mediums, such as magneto-optical discs (MO), CD-R/RWs, and JAZZ, have been developed. Music CDs and read-only optical discs (CD-Rs) are a universally accepted medium. In addition, the CD-R/RW has been widely accepted by consumers. Thus, optical discs have become popular because CD-recorders and CD-R/RWs have fallen in price and optical discs are frequently appended to books or magazines, thereby adding to their popular acceptance.

The prevailing type of optical is the optical disc of 12 cm in diameter, the storage capacity of which is about 640 MB. The use of a 12 cm optical disc, however, wastes storage space when the space required is substantially less than 640 MB. Thus, smaller capacity optical discs have been introduced, for example, optical discs of 8 cm in diameter.

However, the conventional optical disc drive is unable to determine the type of the optical disc before reading the optical disc.

### SUMMARY OF THE INVENTION

The object of the present invention is thus to provide a method of detecting the type of the optical disc in the optical disc drive.

To achieve the above-mentioned object, the present invention provides a method to detect the disc type of the optical disc. A disc spindle motor in the optical disc drive rotates an optical disc. A driving voltage having a predetermined waveform drives the spindle motor. Next, the rotation speed of the spindle motor is detected by Hall sensor and compared with a first predetermined rotation speed and a second predetermined rotation speed. If the rotation speed of the spindle motor is higher than the second predetermined rotation speed, it is determined that there is no optical disc in the optical disc drive. If the rotation speed of the spindle motor is between the first predetermined rotation speed and the second predetermined rotation speed, the optical disc is determined to be an optical disc of 8 cm. If the rotation speed of the spindle motor is slower than the second predetermined rotation speed, the optical disc is determined to be an optical disc of 12 cm.

In addition, the present invention provides an optical disc drive for detecting a type of an optical disc by a spindle motor loading the optical disc. The optical disc drive includes a processor, a memory for recording a plurality of predetermined rotation speeds, and a Hall sensor for detecting a rotation speed of the spindle motor. The processor compares the rotation speed of the spindle motor in a predetermined time with the predetermined rotation speeds to determine the type of the optical disc loaded on the spindle motor. If the rotation speed of the spindle motor is higher than the second predetermined rotation speed, it is determined that there is no optical disc in the optical disc drive. If the rotation speed of the spindle motor is between the first predetermined rotation speed and the second predetermined rotation speed, the optical disc is determined to be an optical disc of 8 cm. If the rotation speed of the spindle motor is slower than the second predetermined rotation speed, the optical disc is determined to be an optical disc of 12 cm.

In addition, the present invention provides a method of using the driving voltage to include a higher voltage level in a first period to overcome static friction of the spindle motor, and a lower voltage level in a second period to drive the rotating spindle motor.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows a block diagram of the optical disc drive according to the embodiment of the present invention.

FIG. 2 shows a waveform of the driving voltage of the spindle motor 10.

FIG. 3 shows a banded distribution of the rotation speed against the measuring time.

FIG. 4 is a flowchart of the disc-type detecting method according to the embodiment of the present invention.

### DETAILED DESCRIPTION OF THE INVENTION

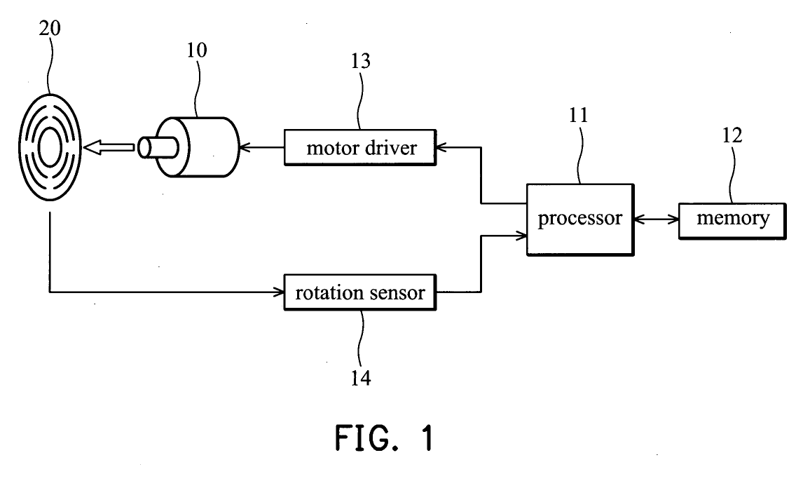

FIG. 1 shows a block diagram of the optical disc drive according to the embodiment of the present invention. The optical disc drive according to the embodiment of the present invention determines whether the type of the optical disc in the optical disc drive is a 12 cm optical disc, or an 8 cm optical disc. The optical disc drive according to the embodiment of the present invention comprises a spindle motor 10 to load and rotate a disc 20, a processor 11, a memory 12, a motor drive 13 and a rotation sensor 14. The memory 12 is connected to the processor 11. The memory 12 records a first predetermined rotation speed and a second predetermined rotation speed faster than the first predetermined rotation speed. The motor drive 13 is connected to the spindle motor 10 to rotate the spindle motor 10. The rotation sensor 14 is connected to the processor 11 to detect the rotation speed of the spindle motor 10.

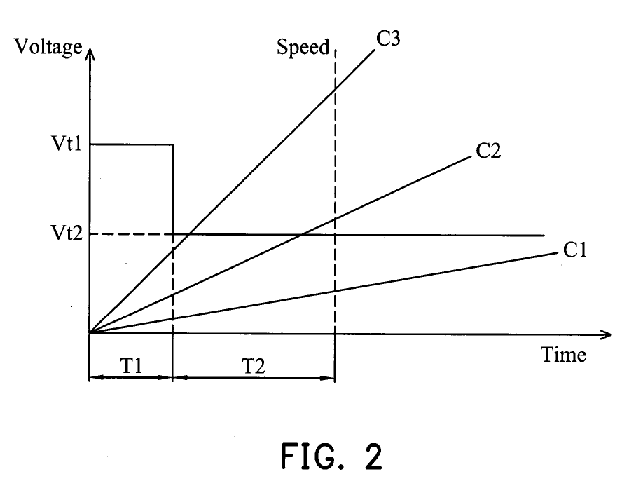

The motor drive 13 drives the spindle motor 10 by a driving voltage having a predetermined waveform. FIG. 2 shows a waveform of the driving voltage of the spindle motor 10. The waveform of the driving voltage comprises a higher voltage level VT1 in the first period T1 and a lower voltage level VT2 in the second period T2. The higher voltage level VT1 overcomes static friction when the spindle motor 10 starts rotating, and the lower voltage level VT2 drives the spindle motor 10 when the spindle motor 10 is rotating.

In FIG. 2, when there is a 12 cm optical disc 21 in the optical disc drive, the angle acceleration of the spindle motor 10 is low because the rotation inertia of the spindle motor 10 is larger. After a predetermined period, the first rotation speed of the spindle motor 10 is low, as shown in the curve C1. When there is no optical disc in the optical disc drive, the angle acceleration of the spindle motor 10 is high because the rotation inertia of the spindle motor 10 is smaller. After a predetermined period, the second rotation speed of the spindle motor 10 is high, as shown in the curve C3. The 8 cm optical disc 22 is however, lighter than the 12 cm optical disc 21. Thus, the angle acceleration of the spindle motor 10 is between the two states mentioned above. After a predetermined period, the rotation speed of the spindle motor 10 is between the first and the second rotation speed, as shown in the curve C2.

Thus, the present invention provides a method to detect the disc type in the optical disc drive by detecting the rotation speed of the spindle motor. No optical disc in the optical disc drive is determined when the rotation speed V of the spindle motor 10 is higher than a first predetermined rotation speed V1 after the predetermined period. A 12 cm optical disc is determined when the rotation speed V of the spindle motor 10 is lower than a second predetermined rotation speed V2 after a predetermined period. If the rotation speed V of the spindle motor 10 is between the first predetermined rotation speed V1 and the second predetermined rotation speed V2 after the predetermined period, the type of the optical disc is determined as an 8 cm optical disc 22

The method of the present invention restores the first predetermined rotation speed V1 and the second predetermined rotation speed V2 in the memory 12, and detects the rotation speed of the spindle motor 10 by the rotation speed sensor 14, for example, a Hall sensor. The processor 11 compares the detected rotation speed with the first predetermined rotation speed V1 and the second predetermined rotation speed V2 to determine the type of the optical disc.

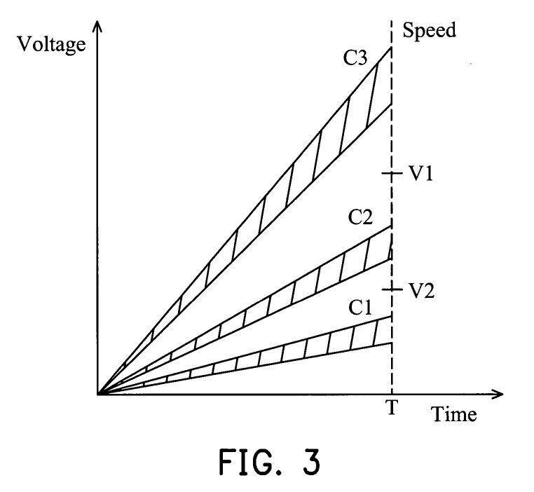

The type of the optical disc is detected according to the sensed waveform of the driving voltage of the spindle motor 10. FIG. 3 shows a banded distribution of the rotation speed against the measuring time. The distribution of the rotation speed is caused by the mass tolerance of the optical discs. Thus, the setting of the supplied voltage and performance time of the optical disc depends on the first predetermined rotation speed V1 and the second predetermined rotation speed V2 to detect the type of optical disc.

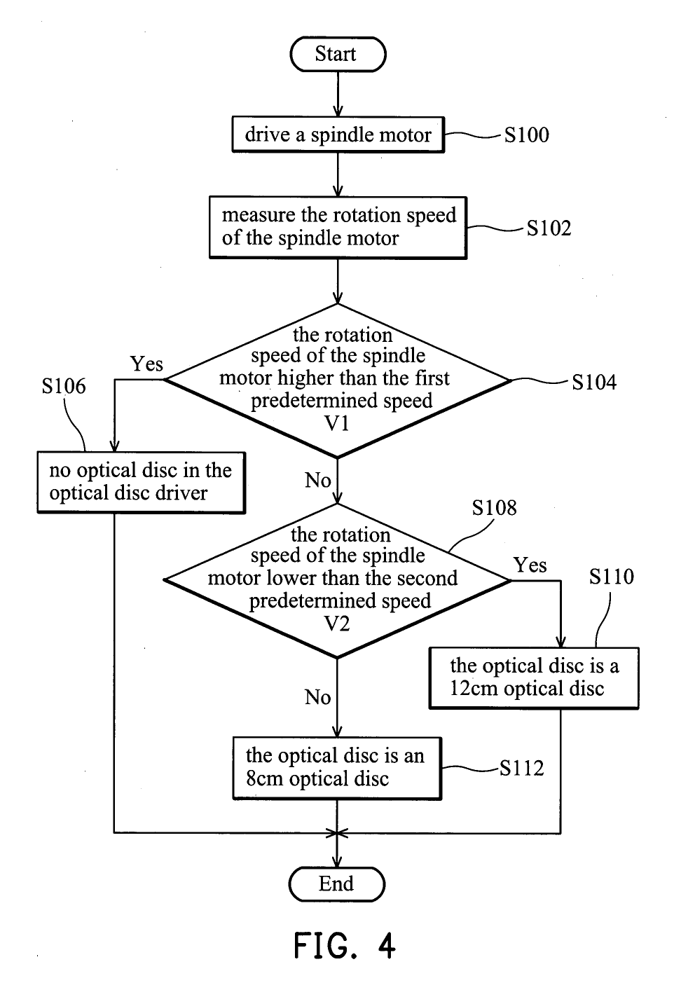

FIG. 4 is a flowchart of the disc-type detecting method according to the embodiment of the present invention. The method comprises the following steps:

In step 100, a voltage having a predetermined waveform is provided to drive a spindle motor 10.

In step S102, the rotation speed of the spindle motor 10 is detected.

In step S104, the rotation speed of the spindle motor 10 is compared with the first predetermined speed V1. If the rotation speed is faster than or equal to the first predetermined speed V1, the process goes to step S106. If the rotation speed is slower than the first predetermined speed V1, the process goes to step S108.

In step S106, no optical disc in the optical disc drive is determined and the process is terminated.

In step S108, the rotation speed of the spindle motor 10 is compared with the second predetermined speed V2. If the rotation speed is slower than or equal to the second predetermined speed V2, the process goes to step S110. If the rotation speed is higher than the second predetermined speed V2, the process goes to step S112.

In step S110, the optical disc in the optical disc drive is determined to be a 12 cm optical disc and the process is terminated.

In step S112, the optical disc in the optical disc drive is determined to be an 8 cm optical disc and the process is terminated.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method of detecting a type of an optical disc according to a rotation speed of a spindle motor loading the optical disc, comprising the following steps:
(a) driving the spindle motor;
(b) detecting the rotation speed of the spindle motor after a predetermined period; and
(c) comparing the rotation speed of the spindle motor with a plurality of predetermined rotation speeds to determine the type of optical disc loaded on the spindle motor.

2. The method of detecting a type of an optical disc as claimed in claim 1, wherein the spindle motor is driven by a voltage having a predetermined waveform.

3. The method of detecting a type of an optical disc as claimed in claim 2, wherein the predetermined waveform comprises a higher voltage level in a first period to overcome static friction of the spindle motor, and a lower voltage level in a second period to drive the rotating spindle motor.

4. The method of detecting a type of an optical disc as claimed in claim 1, wherein the rotation speed of the spindle motor is measured by Hall sensor.

5. The method of detecting a type of an optical disc as claimed in claim 1, wherein no optical disc in the spindle motor is determined when the rotation speed of the spindle motor is higher than the predetermined rotation speeds.

6. The method of detecting a type of optical disc as claimed in claim 1, wherein the predetermined rotation speeds at least comprise a first predetermined rotation speed and a second predetermined rotation speed.

7. The method of detecting a type of an optical disc as claimed in claim 6, wherein the type of the optical disc is determined as an 8 cm optical disc when the rotation speed of the spindle motor is between the first predetermined rotation speed and the second predetermined rotation speed.

8. The method of detecting a type of an optical disc as claimed in claim 6, wherein the type of the optical disc is determined as a 12 cm optical disc when the rotation speed of the spindle motor is slower than the second predetermined rotation speed.

9. The method of detecting a type of an optical disc as claimed in claim 6, wherein the first predetermined rotation speed is slower than the second predetermined rotation speed.

10. An optical disc drive for detecting a type of an optical disc having a spindle motor loading the optical disc, comprising:
a processor;
a memory coupled to the processor for recording a plurality of predetermined rotation speeds; and
a rotation sensor coupled to the processor for detecting a rotation speed of the spindle motor, wherein the processor compares the rotation speed of the spindle motor in a predetermined time with the predetermined rotation speeds to determine the type of the optical disc loaded on the spindle motor.

11. The optical disc drive as claimed in claim 10, further comprising a spindle motor drive to drive the spindle motor by a voltage having a predetermined waveform.

12. The optical disc drive as claimed in claim 11, wherein the predetermined waveform comprises a higher voltage level in a first period to overcome static friction of the spindle motor, and a lower voltage level in a second period to drive the rotating spindle motor.

13. The optical disc drive as claimed in claim 10, wherein the processor compares the rotation speed of the spindle motor with the predetermined rotation speeds, it is determined that there is no optical disc in the spindle motor when the rotation speed of the spindle motor is higher than the predetermined rotation speeds.

14. The optical disc drive as claimed in claim 10, wherein the predetermined rotation speeds at least comprise a first predetermined rotation speed and a second predetermined rotation speed.

15. The optical disc drive as claimed in claim 14, wherein the processor compares the rotation speed of the spindle motor with the first predetermined rotation speed and a second predetermined rotation speed, and the type of the optical disc is determined as a small optical disc (8 cm) when the rotation speed of the spindle motor is between the first predetermined rotation speed and the second predetermined rotation speed.

16. The optical disc drive as claimed in claim 14, wherein the processor compares the rotation speed of the spindle motor with the second predetermined rotation speed, and the type of the optical disc is determined as a normal optical disc (12 cm) when the rotation speed of the spindle motor is slower than the second predetermined rotation speed.

17. The optical disc drive as claimed in claim 14, wherein the first predetermined rotation speed is slower than the second predetermined rotation speed.

18. The optical disc drive as claimed in claim 10, wherein the rotation speed sensor is a Hall sensor.
